(19) United States
(12) Patent Application Publication
(10) Pub. No.: US 2026/0112687 A1
(43) Pub. Date: Apr. 23, 2026

(54) SOLID ELECTROLYTE FOR LITHIUM SECONDARY BATTERY WITH NOVEL CRYSTAL STRUCTURE AND METHOD FOR PRODUCING THE SAME

(71) Applicants: Hyundai Motor Company, Seoul (KR); Kia Corporation, Seoul (KR); Institute of Science Tokyo, Tokyo (JP)

(72) Inventors: In Woo Song, Hwaseong (KR); Hironari Takase, NISHI KU YOKOHAMA SHI (JP); Nam Il Choi, Hwaseong (KR); Yong Jun Jang, Hwaseong (KR); Yuki Sasaki, NISHI KU YOKOHAMA SHI (JP); Ryoji Kanno, Tokyo (JP); Satoshi Hori, Tokyo (JP)

(21) Appl. No.: 19/007,797

(22) Filed: Jan. 2, 2025

(30) Foreign Application Priority Data
Oct. 23, 2024 (JP) 2024-187025

(51) Int. Cl. H01M 10/0562; C01G 17/00

(52) U.S. Cl. CPC H01M 10/0562; C01G 17/006; C01P 2002/30; C01P 2002/72; C01P 2002/76; C01P 2002/77; C01P 2006/40; H01M 2300/0068

(57) ABSTRACT

A solid electrolyte for a lithium secondary battery having a novel crystal structure and a method for producing the same is provided. The solid electrolyte has excellent lithium-ion conductivity and is chemically stable. The solid electrolyte comprises lithium (Li), germanium (Ge), and sulfur (S), forming a ternary compound with Ge₂S₇ polyhedra and GeS₄ tetrahedra in a unit cell. The electrolyte may include compounds such as Li₁₆Ge₅S₁₈ and demonstrates lithium-ion conductivity of at least 8.7×10⁻⁶ S·cm⁻¹ at 25° C. Production methods involve either milling lithium and germanium sulfides to form an amorphous intermediate material, followed by heat treatment, or using crystalline raw materials like Li₂GeS₃ and Li₄GeS₄ directly. Both methods produce a stable, high-conductivity solid electrolyte suitable for all-solid-state lithium batteries, addressing safety and performance limitations of conventional electrolytes.

### CROSS-REFERENCE TO RELATED APPLICATION

This application claims under 35 U.S.C. § 119(a) the benefit of Japan Patent Application No. 2024-187025 filed on Oct. 23, 2024, the entire contents of which are incorporated herein by reference.

### BACKGROUND

### Technical Field

The present disclosure relates to a solid electrolyte for a lithium secondary battery having a novel crystal structure and a method for producing the same, wherein the solid electrolyte has excellent lithium-ion conductivity and is chemically stable.

### Background

Today, lithium secondary batteries are widely used in range of devices, from large applications like automobiles and power storage systems to smaller devices like cell phones, camcorders, and laptops.

As applications for secondary batteries have expanded, demand for improved safety and higher performance has increased.

Lithium secondary batteries, a type of secondary battery, offer advantages over nickel-manganese batteries or nickel-cadmium batteries, including higher energy density and greater capacity per unit volume.

However, most conventional lithium secondary batteries use liquid electrolytes, such as organic solvents, which raise safety concerns related to electrolyte leakage and the associated fire risk.

Accordingly, there is growing interest in all-solid-state batteries that use solid electrolytes instead of liquid electrolytes to enhance the safety of lithium secondary batteries.

Solid electrolytes are non-flammable or flame-retardant, making them safer than liquid electrolytes.

Solid electrolytes are classified into oxide-based and sulfide-based types. Sulfide-based solid electrolytes offer higher lithium-ion conductivity and greater stability over a wide voltage range compared to the oxide-based solid electrolytes. However, they have a disadvantage in that their lower chemical stability can lead to unstable battery operation.

Accordingly, various studies have focused on improving the chemical stability of the sulfide-based solid electrolytes. However, as the chemical safety of the sulfide-based solid electrolytes increases, their essential properties, such as lithium-ion conductivity, are often significantly reduced.

### SUMMARY OF THE DISCLOSURE

The present disclosure has been made in an effort to solve the above-described problems associated with prior art.

An object of the present disclosure is to provide a solid electrolyte for a lithium secondary battery having excellent lithium-ion conductivity while being chemically stable, and a method for producing the same.

Another object of the present disclosure is to provide a solid electrolyte for a lithium secondary battery having a novel crystal structure, and a method for producing the same.

Objects of the present disclosure are not limited to the objects mentioned above. The objects of the present disclosure will become more apparent from the following description and will be achieved by the means and combinations thereof described in the claims.

A solid electrolyte for a lithium secondary battery according to one embodiment of the present disclosure may include lithium (Li), germanium (Ge), and sulfur (S), and may have a monoclinic crystal structure.

The solid electrolyte may include a ternary compound of lithium (Li), germanium (Ge), and sulfur (S).

The unit cell of the monoclinic crystal structure may have a three-dimensional structure including Ge₂S₇ polyhedra and GeS₄ tetrahedra.

The unit cell may include the Ge₂S₇ polyhedra and the GeS₄ tetrahedra at a molar ratio of about 2:1.

The solid electrolyte may have a monoclinic crystal structure with a space group of P2₁.

The solid electrolyte may include a compound represented by Formula 1 below:

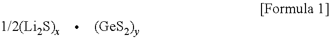

wherein x and y may satisfy the following conditions: 0.71≤x≤0.78, 0.22≤y≤0.29, and x+y=1.

The solid electrolyte may include Li₁₆Ge₅S₁₈.

The solid electrolyte may further include at least one selected from the group consisting of Li₂GeS₃, Li₄GeS₄, and a combination thereof.

The solid electrolyte may show peaks at 2θ diffraction angles of 13.1°±0.5°, 14.0°±0.5°, 14.9°±0.5°, 15.4°±0.5°, 16.3°±0.5°, 16.5°±0.5°, 16.7°±0.5°, 17.1°±0.5°, 17.4°±0.5°, 17.8°±0.5°, 18.5°±0.5°, 19.0°±0.5°, 19.4°±0.5°, 20.0°±0.5°, 21.0°±0.5°, 21.9°±0.5°, 26.3°±0.5°, 26.6°±0.5°, 28.7°±0.5° and 30.0°±0.5° in an X-ray diffraction (XRD) spectrum measured using Cu-Kα radiation.

The solid electrolyte may have a lithium ion conductivity of 8.7×10⁻⁶ S·cm⁻¹ or more at 25° C.

A method for producing a solid electrolyte for a lithium secondary battery according to one embodiment of the present disclosure may include steps of: milling a starting material including lithium sulfide and germanium sulfide to obtain an amorphous intermediate material; and heat-treating the intermediate material to obtain a crystalline solid electrolyte. The crystalline solid electrolyte may include lithium (Li), germanium (Ge), and sulfur (S), and may have a monoclinic crystal structure. AA unit cell of the monoclinic crystal structure may have a three-dimensional structure comprising Ge₂S₇ polyhedra and GeS₄ tetrahedra, and the crystalline solid electrolyte may have a monoclinic crystal structure with a space group of P2₁. The crystalline solid electrolyte may include Li₁₆Ge₅S₁₈. The crystalline solid electrolyte may be obtained by heat-treating the intermediate material at about 530° C. to 620° C.

A method for producing a crystalline solid electrolyte for a lithium secondary battery according to another embodiment of the present disclosure may include steps of: preparing a mixture including a first crystalline raw material and a second crystalline raw material; and heat-treating the mixture to obtain a crystalline solid electrolyte.

The first crystalline raw material may include Li₂GeS₃.

The second crystalline raw material may include Li₄GeS₄.

A unit cell of the monoclinic crystal structure may have a three-dimensional structure comprising Ge₂S₇ polyhedra and GeS₄ tetrahedra, and the crystalline solid electrolyte may have a monoclinic crystal structure with a space group of P2₁.

The crystalline solid electrolyte may include Li₁₆Ge₅S₁₈.

The crystalline solid electrolyte may be obtained by heat-treating the mixture at about 530° C. to about 620° C.

According to the present disclosure, it is possible to provide a solid electrolyte for a lithium secondary battery having excellent lithium-ion conductivity while being chemically stable, and a method for producing the same.

According to the present disclosure, it is possible to provide a solid electrolyte for a lithium secondary battery having a novel crystal structure, and a method for producing the same.

The effects of the present disclosure are not limited to the above-mentioned effects. It is to be understood that the effects of the present disclosure include all effects that may be deduced from the following description.

As discussed, the method and system suitably include use of a controller or processer.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 illustrates a lithium secondary battery according to the present disclosure;

FIG. 2 shows the composition of a solid electrolyte according to the present disclosure as the molar ratio of a ternary system of lithium (Li), germanium (Ge) and sulfur (S);

FIG. 3a and FIG. 3b illustrate the crystal structure of a solid electrolyte according to the present disclosure. FIG. 3a illustrates the crystal structure viewed along the [010] direction, and FIG. 3b illustrates the crystal structure viewed along the [111] direction;

FIG. 4 shows the results of X-ray diffraction (XRD) analysis of Examples 1 to 7 and Comparative Examples 1 and 2;

FIG. 5 shows the results of X-ray diffraction analysis of Examples 2, 8 and 9 and Comparative Examples 3 and 4;

FIG. 6 shows the results of X-ray diffraction analysis of Examples 3 and 10 to 12 and Comparative Examples 5 and 6;

FIG. 7 shows the results of X-ray diffraction analysis of Examples 5 and 13 to 15 and Comparative Examples 7 and 8;

FIG. 8 is a Nyquist diagram of a solid electrolyte according to Example 5.

FIG. 9 is a partial enlarged view of FIG. 8;

FIG. 10 shows the results of calculating the lithium-ion conductivity of the solid electrolyte according to Example 6 using the Nyquist diagram of FIG. 8;

FIG. 11 shows the results of cyclic voltammogram (CV measurement) of an all-solid-state battery including a solid electrolyte layer composed of Li₁₆Ge₅S₁₈;

FIG. 12 is a Nyquist diagram of a solid electrolyte according to the present disclosure before and after exposure;

FIG. 13 is a Nyquist diagram of a solid electrolyte represented by Li₆PS₅Cl before and after exposure; and

FIG. 14 shows the results of measuring the hydrogen sulfide concentrations of a solid electrolyte according to the present disclosure and a solid electrolyte represented by Li₆PS₅Cl as a function of exposure time.

### DETAILED DESCRIPTION OF SPECIFIC EMBODIMENTS

The above objects, other objects, features and advantages of the present disclosure will be better understood from the following description of preferred embodiments taken in conjunction with the accompanying drawings. The present disclosure may, however, be embodied in different forms and should not be construed as limited to the embodiments set forth herein. Rather, the embodiments disclosed herein are provided so that this disclosure will be thorough and complete, and will fully convey the scope of the present disclosure to those skilled in the art.

Unless otherwise noted, like reference numbers refer to like elements throughout the accompanying drawings and the detailed description. In the accompanying drawings, the dimensions of structures are exaggerated for clarity of illustration. Although the terms “first”, “second”, etc. may be used herein to describe various elements or components, these elements or components should not be limited by these terms. These terms are only used to distinguish one element or component from another element or component. For example, a first element or component could be termed a second element or component and vice versa without departing from the scope of the present disclosure. As used herein, the singular forms are intended to include the plural forms as well, unless the context clearly indicates otherwise.

The terms “include,” “comprise,” “including,” or “comprising,” “have”, “having”, etc. are intended to denote the existence of the stated characteristics, numbers, steps, operations, components, parts, or combinations thereof, but do not exclude the probability of existence or addition of one or more other characteristics, numbers, steps, operations, components, parts, or combinations thereof. In addition, when a part, such as a layer, film, region, plate, or the like, is referred to as being “on” or “above” another part, it not only refers to a case where the part is directly above the other part, but also a case where a third part exists therebetween. Conversely, when a part, such as a layer, film, region, plate, or the like, is referred to as being “below” another part, it not only refers to a case where the part is directly below the other part, but also a case where a third part exists therebetween.

Since all numbers, values and/or expressions referring to quantities of components, reaction conditions, polymer compositions, and mixtures used in the present specification are subject to various uncertainties of measurement encountered in obtaining such values, unless otherwise indicated, all are to be understood as modified in all instances by the term “about”. Where a numerical range is disclosed herein, such a range is continuous, inclusive of both the minimum and maximum values of the range as well as every value between such minimum and maximum values, unless otherwise indicated.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

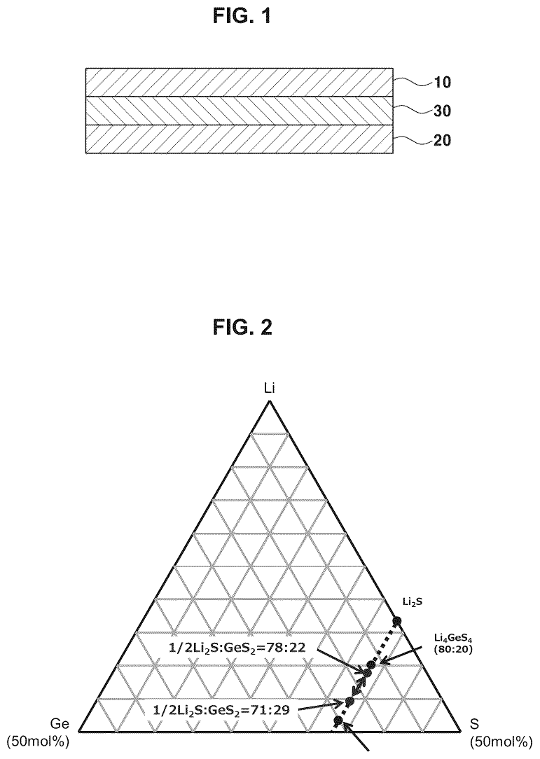

FIG. 1 illustrates a lithium secondary battery according to the present disclosure. The lithium secondary battery may include an all-solid-state battery. The lithium secondary battery may include a positive electrode layer 10, a negative electrode layer 20, and a solid electrolyte layer 30 between the positive electrode layer 10 and the negative electrode layer 20.

At least one of the positive electrode layer 10, the negative electrode layer 20 and the solid electrolyte layer 30 may include a solid electrolyte according to the present disclosure.

The solid electrolyte may include lithium (Li), germanium (Ge), and sulfur (S). Preferably, the solid electrolyte may include a ternary compound of lithium (Li), germanium (Ge), and sulfur (S).

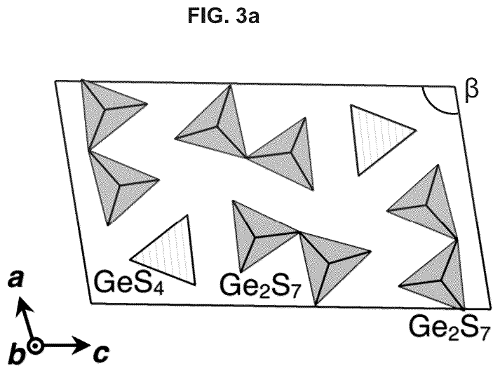

FIG. 2 shows the composition of the solid electrolyte according to the present disclosure as the molar ratio of a ternary system of lithium (Li), germanium (Ge) and sulfur (S). In FIG. 2, germanium (Ge) and sulfur (S) are shown only up to 50 mol %. Referring to FIG. 2, the solid electrolyte may include a compound represented by Formula 1 below:

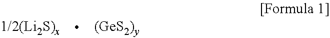

wherein x and y may satisfy the following conditions: 0.71≤x≤0.78, 0.22≤y≤0.29, and x+y=1.

More preferably, the solid electrolyte may include Li₁₆Ge₅S₁₈. In addition, the solid electrolyte may further include at least one selected from the group consisting of Li₂GeS₃, Li₄GeS₄, and a combination thereof. However, the main component of the solid electrolyte may be Li₁₆Ge₅S₁₈, and Li₂GeS₃, Li₄GeS₄, etc. may be minor components. The minor components may or may not satisfy Formula 1 above. The specific content of the main component is not particularly limited, but may be, for example, 50 mol % or more, 60 mol % or more, 70 mol % or more, 80 mol % or more, 90 mol % or more, 95 mol % or more, or 99 mol % or more.

The solid electrolyte may have a monoclinic crystal structure. Since the existing ternary compound Li₂GeS₃ of lithium (Li), germanium (Ge), and sulfur (S) has a hexagonal crystal structure and the ternary compound Li₄GeS₄ has an orthorhombic crystal structure, the solid electrolyte according to the present disclosure can be said to have a novel crystal structure different from those of the existing solid electrolytes.

The solid electrolyte may show peaks at 2θ diffraction angles of 13.1°±0.5°, 14.0°±0.5°, 14.9°±0.5°, 15.4°±0.5°, 16.3°±0.5°, 16.5°±0.5°, 16.7°±0.5°, 17.1°±0.5°, 17.4°±0.5°, 17.8°±0.5°, 18.5°±0.5°, 19.0°±0.5°, 19.4°±0.5°, 20.0°±0.5°, 21.0°±0.5°, 21.9°±0.5°, 26.3°±0.5°, 26.6°±0.5°, 28.7°±0.5° and 30.0°±0.5° in an X-ray diffraction (XRD) spectrum measured using Cu-Kα radiation.

The crystal structure of the solid electrolyte may be determined by synchrotron X-ray diffraction (synchrotron XRD). For example, the crystal structure of the solid electrolyte may be determined by performing Rietveld refinement of the diffraction data obtained by analyzing the solid electrolyte by synchrotron XRD. Thereby, it can be determined that the solid electrolyte according to the present disclosure has a monoclinic crystal structure with a space group of P2₁, and that the diffraction data can be indexed with lattice constants: a=11.68 Å, b=6.23 Å, c=20.68 Å, and β=100°.

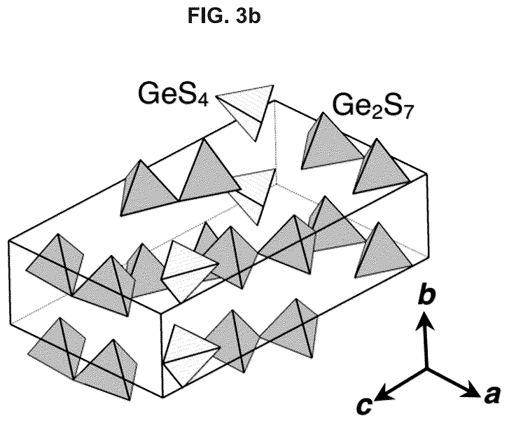

FIGS. 3a and 3b illustrate the crystal structure of a solid electrolyte according to the present disclosure. Specifically, FIG. 3a illustrates the crystal structure viewed along the [010] direction, and FIG. 3b illustrates the crystal structure viewed along the [111] direction.

Referring to FIGS. 3a and 3b, the unit cell of the solid electrolyte may include Ge₂S₇ polyhedra and GeS₄ tetrahedra. The Ge₂S₇ polyhedra is formed by corner-sharing between two GeS₄ tetrahedra. The unit cell may include the Ge₂S₇ polyhedra and the GeS₄ tetrahedra at a molar ratio of 2:1, and accordingly, the composition of the solid electrolyte may be predicted to be Li₁₆Ge₅S₁₈.

The solid electrolyte according to the present disclosure has excellent lithium-ion conductivity and, at the same time, excellent chemical stability, particularly stability against water. The solid electrolyte may have a lithium ion conductivity of 8.7×10⁻⁶ S·cm⁻¹ or more at 25° C. The lithium-ion conductivity of the solid electrolyte may be measured using electrochemical impedance spectroscopy. For example, the total resistance including bulk and grain resistance may be determined from the diameter of the semicircle of the Nyquist diagram of the impedance data for the solid electrolyte, and the lithium-ion conductivity may be calculated using the same.

A method for producing a solid electrolyte according to one embodiment of the present disclosure may include steps of: obtaining an amorphous intermediate material by milling a starting material including lithium sulfide and germanium sulfide; and obtaining a crystalline solid electrolyte by heat-treating the intermediate material.

The lithium sulfide may include Li₂S, Li₂S₂, Li₂S₄, Li₂S₈, etc., and preferably may include Li₂S. The germanium sulfide may include GeS₂, GeS, etc., and preferably may include GeS₂. The starting material may be prepared by weighing the lithium sulfide and germanium sulfide according to the composition of the target compound.

The method and conditions for milling the starting material are not particularly limited. For example, the amorphous intermediate material may be obtained by milling the starting material a device such as a ball mill for about 15 to 30 hours.

The step of obtaining the solid electrolyte may be performed by heat-treating the amorphous intermediate material at 530° C. to 620° C. If the temperature of the heat treatment is lower than 530° C., the solid electrolyte may not be sufficiently crystallized, which may result in a decrease in the lithium ion conductivity, and if the temperature of the heat treatment is higher than 620° C., the solid electrolyte may form a crystal structure other than a monoclinic crystal structure, which may result in a decrease in the lithium ion conductivity and a decrease in the efficiency of the production method. The time of the heat treatment is not particularly limited, but may be, for example, 5 to 20 hours.

A method for producing a solid electrolyte according to another embodiment of the present disclosure may include steps of: preparing a mixture including a first crystalline raw material and a second crystalline raw material; and obtaining a crystalline solid electrolyte by heat-treating the mixture. Unlike the above-described production method according to one embodiment, the production method according to this embodiment uses a crystalline raw material. Therefore, there is no need to crystallize through heat treatment after amorphization through milling or the like, and thus the production time may be significantly shortened.

The first raw material may include Li₂GeS₃. The second raw material may include Li₄GeS₄. The first raw material and/or the second raw material may be commercially available or may be obtained by reacting lithium sulfide and germanium sulfide.

A mixture may be prepared by simply mixing the first and second raw materials. The mixing method and conditions are not particularly limited, and the mixture may be prepared by mixing the first and second raw materials using a stirrer or the like for about 1 minute to 1 hour.

The step of obtaining the solid electrolyte may be performed by heat-treating the mixture at 530° C. to 620° C. If the temperature of the heat treatment is lower than 530° C., the solid electrolyte may not be sufficiently crystallized, which may result in a decrease in the lithium ion conductivity, and if the temperature of the heat treatment is higher than 620° C., the solid electrolyte may form a crystal structure other than a monoclinic crystal structure, which may result in a decrease in the lithium ion conductivity and a decrease in the efficiency of the production method. The time of the heat treatment is not particularly limited, but may be, for example, 5 to 20 hours.

Hereinafter, the present disclosure will be described in more detail by way of examples. The following examples are only examples to help the understanding of the present disclosure, and the scope of the present disclosure is not limited thereto.

### Example 1

A starting material including Li₂S and GeS₂ at the molar ratio shown in Table 1 below was prepared. The starting material was placed in a ball mill (Pulverisette 7, Fritsch, Idar-Oberstein, Germany). After the interior of the ball mill was filled with argon gas, the starting material was ground at about 370 rpm for about 30 hours to obtain an amorphous intermediate material. The intermediate material was heat-treated at about 550° C. in an argon gas atmosphere to obtain a crystalline solid electrolyte.

### Examples 2 to 7

Crystalline solid electrolytes were produced in the same manner as in Example 1, except that the molar ratio of Li₂S and GeS₂ was changed as shown in Table 1 below.

### Examples 8 and 9

Crystalline solid electrolytes were produced in the same manner as in Example 2 using the same molar ratio of Li₂S and GeS₂ as in that in Example 2, except that the temperature of heat treatment was changed as shown in Table 1 below.

### Examples 10 to 12

Crystalline solid electrolytes were produced in the same manner as in Example 3 using the same molar ratio of Li₂S and GeS₂ as in that in Example 3, except that the temperature of heat treatment was changed as shown in Table 1 below.

### Examples 13 to 15

Crystalline solid electrolytes were produced in the same manner as in Example 5 using the same molar ratio of Li₂S and GeS₂ as in that in Example 5, except that the temperature of heat treatment was changed as shown in Table 1 below.

### Example 16

Crystalline Li₂GeS₃ and crystalline Li₄GeS₄ were mixed together at the molar ratio shown in Table 1 below for about 5 minutes to obtain a mixture. The mixture was heat-treated at about 550° C. to obtain a crystalline solid electrolyte.

### Comparative Examples 1 and 2

Crystalline solid electrolytes were produced in the same manner as in Example 1, except that the molar ratio of Li₂S and GeS₂ was changed as shown in Table 2 below. Specifically, Comparative Example 1 is a sample having a molar ratio lower than the molar ratio of 1/2 (Li₂S) and GeS₂ presented in the present disclosure, and Comparative Example 2 is a sample having a molar ratio higher than the molar ratio of 1/2 (Li₂S) and GeS₂ presented in the present disclosure.

### Comparative Examples 3 and 4

Crystalline solid electrolytes were produced in the same manner as in Example 2 using the same molar ratio of Li₂S and GeS₂ as that in Example 2, except that the temperature of heat treatment was changed as shown in Table 2 below. Specifically, Comparative Example 3 is a sample obtained by heat treatment at a temperature lower than the heat treatment temperature presented in the present disclosure, and Comparative Example 4 is a sample obtained by heat treatment at a temperature higher than the heat treatment temperature presented in the present disclosure.

### Comparative Examples 5 and 6

Crystalline solid electrolytes were produced in the same manner as in Example 3 using the same molar ratio of Li₂S and GeS₂ as that in Example 3, except that the temperature of heat treatment was changed as shown in Table 2 below. Specifically, Comparative Example 5 is a sample obtained by heat treatment at a temperature lower than the heat treatment temperature presented in the present disclosure, and Comparative Example 6 is a sample obtained by heat treatment at a temperature higher than the heat treatment temperature presented in the present disclosure.

### Comparative Examples 7 and 8

Crystalline solid electrolytes were produced in the same manner as in Example 5 using the same molar ratio of Li₂S and GeS₂ as that in Example 5, except that the temperature of heat treatment was changed as shown in Table 2 below. Specifically, Comparative Example 7 is a sample obtained by heat treatment at a temperature lower than the heat treatment temperature presented in the present disclosure, and Comparative Example 8 is a sample obtained by heat treatment at a temperature higher than the heat treatment temperature presented in the present disclosure.

Tables 1 and 2 below show the main component, minor component, crystal structure, and lithium-ion conductivity of the solid electrolyte produced in each of Examples 1 to 16 and Comparative Examples 1 to 8.

TABLE 1

| | | ½ | | Heat | | | | |
|---|---|---|---|---|---|---|---|---|
| | | (Li₂S) | GeS₂ | treatment | | | | Lithium ion |
| | Raw | [molar | [molar | temperature | Main | Minor | Crystal | conductivity |
| | material | ratio] | ratio] | [° C.] | component | component | structure | [S · cm⁻¹] |
| Example 1 | Glass | 71 | 29 | 550 | Li₁₆Ge₅S₁₈ | Li₂GeS₃ | Monoclinic | 8.7 × 10⁻⁶ |
| Example 2 | Glass | 75 | 25 | 550 | Li₁₆Ge₅S₁₈ | Li₂GeS₃ | | 5.4 × 10⁻⁵ |
| Example 3 | Glass | 75.8 | 24.2 | 550 | Li₁₆Ge₅S₁₈ | Li₂GeS₃ | | 5.7 × 10⁻⁵ |
| Example 4 | Glass | 76 | 24 | 550 | Li₁₆Ge₅S₁₈ | Li₄GeS₄ | | 7.2 × 10⁻⁵ |
| Example 5 | Glass | 76.2 | 23.8 | 550 | Li₁₆Ge₅S₁₈ | Li₄GeS₄ | | 7.1 × 10⁻⁵ |
| Example 6 | Glass | 76.5 | 23.5 | 550 | Li₁₆Ge₅S₁₈ | Li₄GeS₄ | | 5.7 × 10⁻⁵ |
| Example 7 | Glass | 78 | 22 | 550 | Li₁₆Ge₅S₁₈ | Li₄GeS₄ | | 2.0 × 10⁻⁵ |
| Example 8 | Glass | 75 | 25 | 530 | Li₁₆Ge₅S₁₈ | Li₂GeS₃ | | 3.4 × 10⁻⁵ |
| Example 9 | Glass | 75 | 25 | 620 | Li₁₆Ge₅S₁₈ | Li₂GeS₃ | | 6.7 × 10⁻⁵ |
| Example 10 | Glass | 75.8 | 24.2 | 530 | Li₁₆Ge₅S₁₈ | Li₂GeS₃ | | 1.5 × 10⁻⁵ |
| | | | | | | Li₄GeS₄ | | |
| Example 11 | Glass | 75.8 | 24.2 | 600 | Li₁₆Ge₅S₁₈ | Li₄GeS₄ | | 2.4 × 10⁻⁵ |
| Example 12 | Glass | 75.8 | 24.2 | 620 | Li₁₆Ge₅S₁₈ | Li₄GeS₄ | | 2.6 × 10⁻⁵ |
| Example 13 | Glass | 76.2 | 23.8 | 530 | Li₁₆Ge₅S₁₈ | Li₄GeS₄ | | 6.5 × 10⁻⁵ |
| Example 14 | Glass | 76.2 | 23.8 | 600 | Li₁₆Ge₅S₁₈ | Li₄GeS₄ | | 1.2 × 10⁻⁵ |
| Example 15 | Glass | 76.2 | 23.8 | 620 | Li₁₆Ge₅S₁₈ | Li₄GeS₄ | | 3.1 × 10⁻⁵ |
| Example 16 | Li₂GeS₂ + | 75 | 25 | 550 | Li₁₆Ge₅S₁₈ | Li₂GeS₃ | | 4.2 × 10⁻⁵ |
| | Li₄GeS₄ | | | | | | | |

TABLE 2

| | | ½ | | Heat | | | | |
|---|---|---|---|---|---|---|---|---|
| | | (Li₂S) | GeS₂ | treatment | | | | Lithium ion |
| | Raw | [molar | [molar | temperature | Main | Minor | Crystal | conductivity |
| | material | ratio] | ratio] | [° C.] | component | component | structure | [S · cm⁻¹] |
| Comp. | Glass | 67 | 33 | 550 | Li₂GeS₃ | — | Hexagonal | 8.6 × 10⁻⁹ |
| Example 1 | | | | | | | | |
| Comp. | Glass | 80 | 20 | 550 | Li₄GeS₄ | — | Orthorhombic | 1.9 × 10⁻⁶ |
| Example 2 | | | | | | | | |
| Comp. | Glass | 75 | 25 | 520 | Li₂GeS₃ | — | Hexagonal and | 4.3 × 10⁻⁷ |
| Example 3 | | | | | Li₄GeS₄ | | orthorhombic | |
| Comp. | Glass | 75 | 25 | 650 | | Unknown | | 5.7 × 10⁻⁶ |
| Example 4 | | | | | | | | |
| Comp. | Glass | 75.8 | 24.2 | 520 | | — | | 5.9 × 10⁻⁷ |
| Example 5 | | | | | | | | |
| Comp. | Glass | 75.8 | 24.2 | 650 | Li₄GeS₄ | Unknown | Orthorhombic | 8.3 × 10⁻⁶ |
| Example 6 | | | | | | | | |
| Comp. | Glass | 76.2 | 23.8 | 520 | Li₂GeS₃ | — | Hexagonal and | 9.5 × 10⁻⁷ |
| Example 7 | | | | | | | orthorhombic | |
| Comp. | Glass | 76.2 | 23.8 | 650 | Li₄GeS₄ | Unknown | Orthorhombic | 1.1 × 10⁻⁵ |
| Example 8 | | | | | | | | |

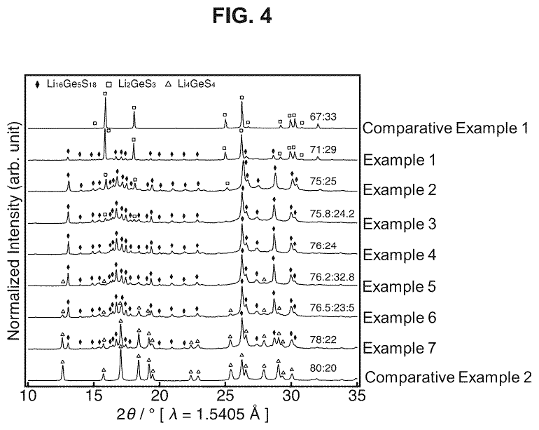

Referring to Examples 1 to 7 and Comparative Examples 1 and 2, Examples 1 to 7 in which the molar ratio of 1/2 (Li₂S) to GeS₂ is 71:29 to 78:22 have higher lithium-ion conductivity than Comparative Examples 1 and 2 in which the molar ratio is out of the above range. FIG. 4 shows the results of X-ray diffraction (XRD) analysis of Examples 1 to 7 and Comparative Examples 1 and 2. Examples 1 to 7 include Li₁₆Ge₅S₁₈ as the main component and have a monoclinic crystal structure, whereas Comparative Example 1 includes Li₂GeS₂ as the main component and has a hexagonal crystal structure, and Comparative Example 2 includes Li₄GeS₄ as the main component and has an orthorhombic crystal structure.

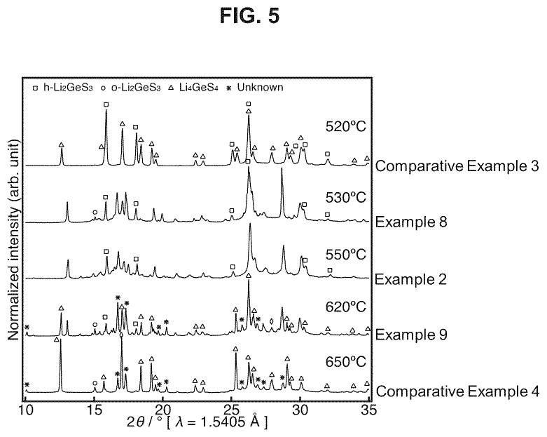

Referring to Examples 2, 8 and 9 and Comparative Examples 3 and 4, Examples 8 and 9, in which the heat treatment temperature is 530° C. to 620° C., have higher lithium ion conductivity than Comparative Examples 3 and 4. FIG. 5 shows the results of X-ray diffraction analysis of Examples 2, 8 and 9 and Comparative Examples 3 and 4. Examples 8 and 9 include Li₁₆Ge₅S₁₈ as the main component and have a monoclinic crystal structure, like Example 2. On the other hand, Comparative Examples 3 and 4 show a mixed phase of Li₂GeS₂ and Li₄GeS₄ and have a mixed crystal structure of hexagonal and orthorhombic crystal structures.

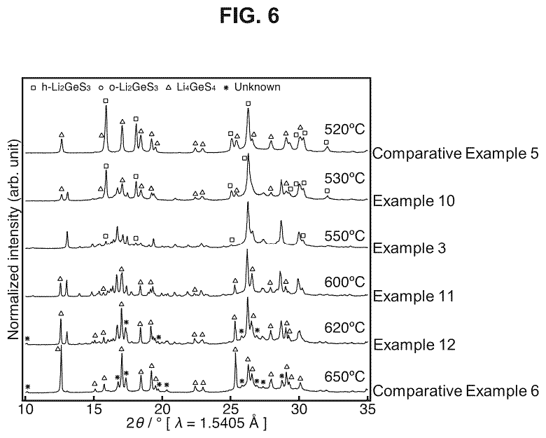

Referring to Examples 3 and 10 to 12 and Comparative Examples 5 and 6, Example 3 and Examples 10 to 12, in which the heat treatment temperature is 530° C. to 620° C., have higher lithium ion conductivity than Comparative Examples 5 and 6. FIG. 6 shows the results of X-ray diffraction analysis of Example 3, Examples 10 to 12, and Comparative Examples 5 and 6. Examples 10 to 12 include Li₁₆Ge₅S₁₈ as the main component and have a monoclinic crystal structure, like Example 3. On the other hand, Comparative Example 5 shows a mixed phase of Li₂GeS₂ and Li₄GeS₄ and has a mixed crystal structure of hexagonal and orthorhombic crystal structures, and Comparative Example 5 includes Li₄GeS₄ as the main component and has an orthorhombic crystal structure.

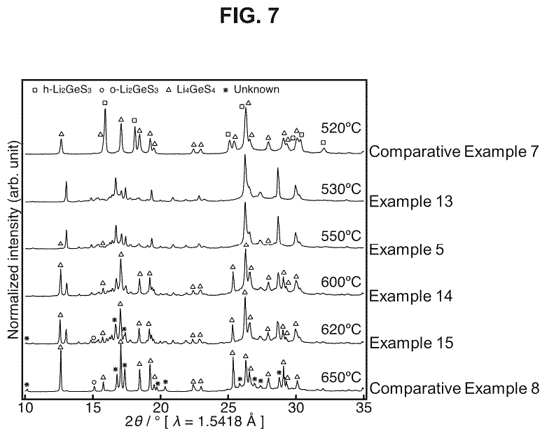

Referring to Examples 5 and 13 to 15 and Comparative Examples 7 and 8, Examples 5 and 13 to 15, in which the heat treatment temperature is 530° C. to 620° C., have higher lithium ion conductivity than Comparative Examples 7 and 8. FIG. 7 shows the results of X-ray diffraction analysis of Examples 5 and 13 to 15 and Comparative Examples 7 and 8. Examples 13 and 15 include Li₁₆Ge₅S₁₈ as the main component and have a monoclinic crystal structure, like Example 5. On the other hand, Comparative Example 7 shows a mixed phase of Li₂GeS₂ and Li₄GeS₄ and has a mixed crystal structure of hexagonal and orthorhombic crystal structures, and Comparative Example 8 includes Li₄GeS₄ as the main component and has an orthorhombic crystal structure.

The above results suggest that, even if the composition is the same, the main component and crystal structure change depending on the heat treatment temperature, which in turn causes a change in the lithium-ion conductivity.

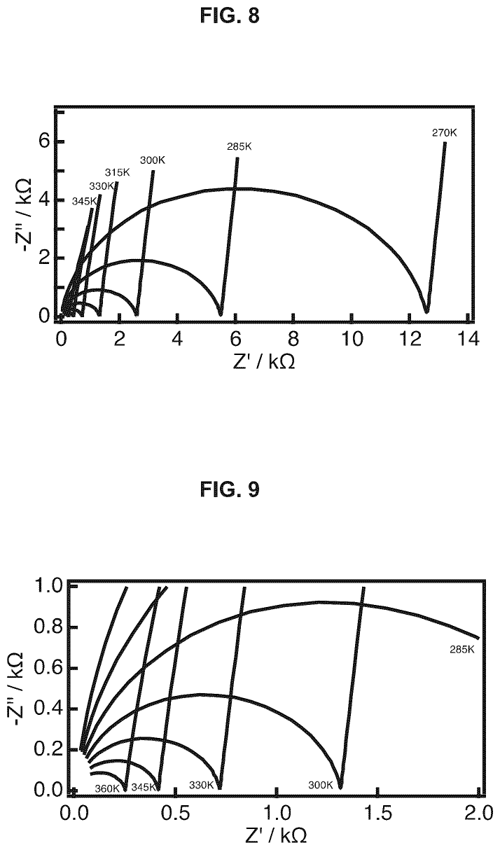

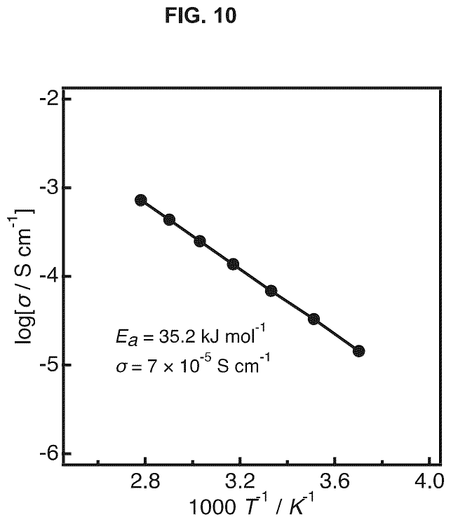

FIG. 8 is a Nyquist diagram of the solid electrolyte according to Example 5. The temperature dependence of the solid electrolyte was evaluated by varying the measurement temperature. FIG. 9 is a partial enlarged view of FIG. 8. FIG. 10 shows the results of calculating the lithium-ion conductivity of the solid electrolyte according to Example 6 using the Nyquist diagram of FIG. 8. Referring to FIG. 10, it can be seen that the lithium-ion conductivity of the solid electrolyte according to the present disclosure linearly increases as the temperature increases.

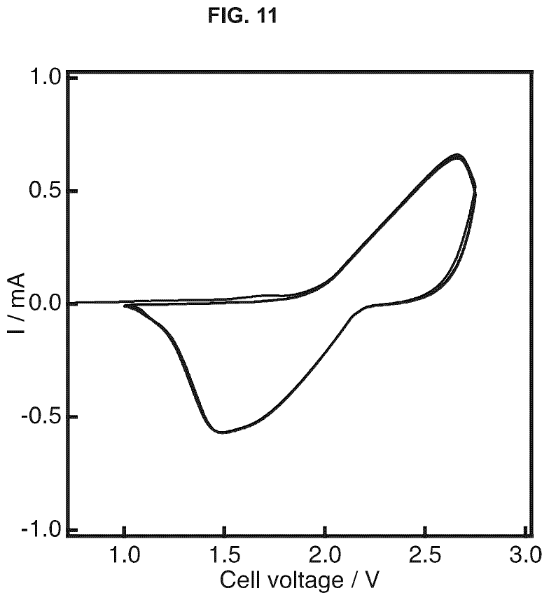

FIG. 11 shows the results of cyclic voltammogram (CV measurement) of an all-solid-state battery including a solid electrolyte layer composed of Li₁₆Ge₅S₁₈. A positive electrode layer was fabricated by mixing LiNbO₃ coated NCM 811 (LiNi_{0.8}Co_{0.1}Mn_{0.1}O₂), a positive electrode active material, with a solid electrolyte, a conductive material, and a binder. A solid electrolyte layer was fabricated using the solid electrolyte including Li₁₆Ge₅S₁₈ according to the present disclosure. A negative electrode layer was fabricated by mixing the negative electrode active material LTO (Li₄Ti₅O₁₂) with a solid electrolyte, a conductive material and a binder. An all-solid-state battery, such as that shown in FIG. 1, in which the solid electrolyte layer is positioned between the positive electrode layer and the negative electrode layer, was fabricated, and the electrochemical properties of the all-solid-state battery were measured under test conditions of 0.05 mV·s⁻¹, 1.00 V to 2.75 V, and 25° C. Referring to FIG. 11, it can be seen that a reversible redox reaction occurs well in the all-solid-state battery including the solid electrolyte according to the present disclosure, and that the all-solid-state battery operates stably.

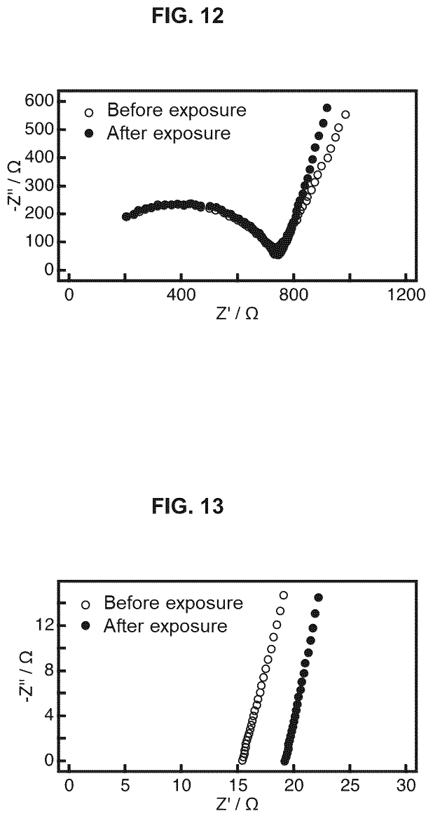

The water stability of the solid electrolyte according to the present disclosure was evaluated. The resistance of the solid electrolyte after exposure to an atmosphere having a dew point of −30° C. for 30 minutes was compared with the resistance before exposure. FIG. 12 is a Nyquist diagram of the solid electrolyte according to the present disclosure before and after exposure. The resistance of the solid electrolyte according to the present disclosure before exposure to the above-described atmosphere was about 747Ω, and the resistance thereof after exposure was about 749Ω, which increased by about 0.3%.

For comparison, the water stability of the solid electrolyte represented by Li₆PS₅Cl was evaluated in the same manner. FIG. 13 is a Nyquist diagram of the solid electrolyte represented by Li₆PS₅Cl before and after exposure. The resistance of the solid electrolyte represented by Li₆PS₅Cl before exposure at the above-described atmosphere was about 15Ω, and the resistance thereof after exposure was about 19Ω, which increased by about 26.7%.

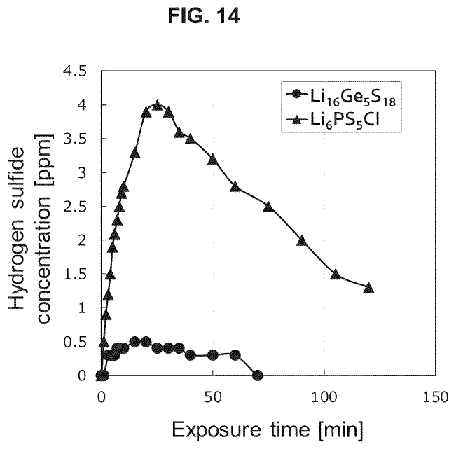

FIG. 14 shows the results of measuring the hydrogen sulfide concentrations of the solid electrolyte according to the present disclosure and the solid electrolyte represented by Li₆PS₅Cl as a function of exposure time. Since the sulfur element in the solid electrolyte reacts with water to generate hydrogen sulfide, the water stability of the solid electrolyte can be evaluated through the concentration of the hydrogen sulfide. Referring to FIG. 14, it can be seen that the solid electrolyte according to the present disclosure has a hydrogen sulfide concentration of no more than 0.5 ppm during the entire exposure time, whereas the hydrogen sulfide concentration of the solid electrolyte represented by Li₆PS₅Cl increases up to about 4 ppm.

Thereby, it can be seen that the solid electrolyte according to the present disclosure has better water stability than the existing solid electrolyte.

Although the embodiments of the present disclosure have been described in detail above, the scope of the present disclosure is not limited to the above-described embodiments, and those skilled in the art will appreciate that various modifications and improvements using the basic concepts of the present disclosure as defined in the appended claims also fall within the scope of the present disclosure.

What is claimed is:

1. A solid electrolyte for a lithium secondary battery, the solid electrolyte comprising lithium (Li), germanium (Ge), and sulfur (S) and having a monoclinic crystal structure.

2. The solid electrolyte of claim 1, wherein the solid electrolyte comprises a ternary compound of lithium (Li), germanium (Ge), and sulfur (S).

3. The solid electrolyte of claim 1, wherein a unit cell of the monoclinic crystal structure has a three-dimensional structure comprising Ge₂S₇ polyhedra and GeS₄ tetrahedra.

4. The solid electrolyte of claim 3, wherein the unit cell comprises the Ge₂S₇ polyhedra and the GeS₄ tetrahedra at a molar ratio of about 2:1.

5. The solid electrolyte of claim 1, wherein the solid electrolyte has a monoclinic crystal structure with a space group of P2₁.

6. The solid electrolyte of claim 1, wherein the solid electrolyte comprises a compound represented by Formula 1 below: 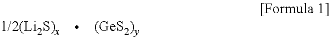
wherein x and y satisfy the following conditions: 0.71≤x≤0.78, 0.22≤y≤0.29, and x+y=1.

7. The solid electrolyte of claim 1, wherein the solid electrolyte comprises Li₁₆Ge₅S₁₈.

8. The solid electrolyte of claim 7, wherein the solid electrolyte further comprises at least one selected from the group consisting of Li₂GeS₃, Li₄GeS₄, and a combination thereof.

9. The solid electrolyte of claim 1, wherein the solid electrolyte shows peaks at 20 diffraction angles of 13.1°±0.5°, 14.0°±0.5°, 14.9°±0.5°, 15.4°±0.5°, 16.3°±0.5°, 16.5°±0.5°, 16.7°±0.5°, 17.1°±0.5°, 17.4°±0.5°, 17.8°±0.5°, 18.5°±0.5°, 19.0°±0.5°, 19.4°±0.5°, 20.0°±0.5°, 21.0°±0.5°, 21.9°±0.5°, 26.3°±0.5°, 26.6°±0.5°, 28.7°±0.5° and 30.0°±0.5° in an X-ray diffraction (XRD) spectrum measured using Cu-Kα radiation.

10. The solid electrolyte of claim 1, wherein the solid electrolyte has a lithium-ion conductivity of 8.7×10⁻⁶ S·cm⁻¹ or more at 25° C.

11. A method for producing a crystalline solid electrolyte for a lithium secondary battery, the method comprising steps of:
milling a starting material comprising lithium sulfide and germanium sulfide to obtain an amorphous intermediate material; and
heat-treating the intermediate material to obtain a crystalline solid electrolyte,
wherein the crystalline solid electrolyte comprises lithium (Li), germanium (Ge), and sulfur (S), and has a monoclinic crystal structure.

12. The method of claim 11, wherein a unit cell of the monoclinic crystal structure has a three-dimensional structure comprising Ge₂S₇ polyhedra and GeS₄ tetrahedra, and the crystalline solid electrolyte has a monoclinic crystal structure with a space group of P2₁.

13. The method of claim 11, wherein the crystalline solid electrolyte comprises Li₁₆Ge₅S₁₈.

14. The method of claim 11, wherein the crystalline solid electrolyte is obtained by heat-treating the intermediate material at about 530° C. to about 620° C.

15. A method for producing a crystalline solid electrolyte for a lithium secondary battery, the method comprising steps of:
preparing a mixture comprising a first crystalline raw material and a second crystalline raw material; and
heat-treating the mixture to obtain a crystalline solid electrolyte,
wherein the crystalline solid electrolyte comprises lithium (Li), germanium (Ge), and sulfur (S), and has a monoclinic crystal structure.

16. The method of claim 15, wherein the first crystalline raw material comprises Li₂GeS₃.

17. The method of claim 15, wherein the second crystalline raw material comprises Li₄GeS₄.

18. The method of claim 15, wherein a unit cell of the monoclinic crystal structure has a three-dimensional structure comprising Ge₂S₇ polyhedra and GeS₄ tetrahedra, and the crystalline solid electrolyte has a monoclinic crystal structure with a space group of P2₁.

19. The method of claim 15, wherein the crystalline solid electrolyte comprises Li₁₆Ge₅S₁₈.

20. The method of claim 15, wherein the crystalline solid electrolyte is obtained by heat-treating the mixture at about 530° C. to about 620° C.
